(19) United States
(12) Patent Application Publication
(10) Pub. No.: US 2024/0013513 A1
(43) Pub. Date: Jan. 11, 2024

(54) CLASSIFYING PRODUCTS FROM IMAGES

(71) Applicant: WorldApp, Inc., Braintree, MA (US)

(72) Inventors: Jonathan Morra, El Segundo, CA (US); Rafal Cycon, Kraków (PL); Christopher Osufsen, New York, NY (US); Krzysztof Kolasinski, Kraków (PL)

(21) Appl. No.: 18/311,442

(22) Filed: May 3, 2023

Related U.S. Application Data
(60) Provisional application No. 63/358,786, filed on Jul. 6, 2022.

(51) Int. Cl. G06V 10/764; G06T 7/70; G06T 7/60; G06V 10/774; G06V 20/50; G06V 20/70; G06V 10/26; G06V 20/62; G06K 7/14

(52) U.S. Cl. CPC G06V 10/764; G06T 7/70; G06T 7/60; G06V 10/774; G06V 20/50; G06V 20/70; G06V 10/26; G06V 20/63; G06K 7/1413; G06T 2207/20081

(57) ABSTRACT

For classifying products, a method trains a supervised learning product model, wherein the product model embeds product embeddings of a same product close to another product in a latent space of a vector database. The method further generates the vector database of the product embeddings for the plurality of the product images, wherein the vector database comprises product embeddings of known products and unknown products. The method generates a new product embedding for a new product. The method queries the vector database with the new product embedding as a centroid for a proximity query, wherein the new product embedding is a novel distance from other product embeddings in the vector database. The method labels close product embeddings from the vector database as the new product. The method adds the new product to the product detector using product images extracted from within a group of the vector database.

### CROSS-REFERENCE TO RELATED APPLICATIONS

This application claims priority to U.S. Provisional Patent Application No. 63/358,786 entitled “CLASSIFYING PRODUCTS FROM IMAGES” and filed on Jul. 5, 2022, for Jonathan Morra, which is incorporated herein by reference.

### BACKGROUND INFORMATION

The shelves of retail establishments are often audited by capturing an image of the shelves.

### BRIEF DESCRIPTION

A method for classifying products from images is disclosed. The method trains a supervised learning product model comprising a product classifier, a Stock Keeping Unit (SKU) classifier, a price classifier, a brand classifier, a shelf detector, a dimension estimator, a refrigerator detector, and an orientation classifier, wherein the product model embeds product embeddings of a same product close to another product in a latent space of a vector database. The method generates a product embedding for a plurality of product images of segmented products using the product model. The method further generates the vector database of the product embeddings for the plurality of the product images, wherein the vector database comprises product embeddings of known products and unknown products. The method generates a new product embedding for a new product. The method queries the vector database with the new product embedding as a centroid for a proximity query, wherein the new product embedding is a novel distance from other product embeddings in the vector database. The method labels close product embeddings from the vector database as the new product. The method adds the new product to the product classifier using product images extracted from within a product embedding group of the vector database. An apparatus and computer program product also perform the functions of the apparatus.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic drawing illustrating one embodiment of a shelf;

FIG. 1B is a schematic drawing illustrating one alternate embodiment of a shelf;

FIG. 1C is a schematic block diagram illustrating one embodiment of a classification system;

FIG. 1D is a schematic block diagram illustrating one embodiment of the product model;

FIG. 2A is a schematic block diagram illustrating one embodiment of classification data;

FIG. 2B is a schematic block diagram illustrating one embodiment of product data;

FIG. 2C is a schematic block diagram illustrating one embodiment of shelf data;

FIG. 2D is a schematic block diagram illustrating one embodiment of a vector database;

FIG. 2E is a schematic block diagram illustrating one embodiment of a product embedding;

FIG. 3A is a diagram illustrating one embodiment of a vector database;

FIG. 3B is a diagram illustrating one alternate embodiment of a vector database;

FIG. 4A is a schematic block diagram illustrating one embodiment of a computer 400;

FIG. 4B is a schematic diagram illustrating one embodiment of a neural network 475;

FIG. 5A is a schematic flow chart diagram illustrating one embodiment of a product classification method 500; and

FIG. 5B is a schematic flow chart diagram illustrating one embodiment of a compliance determination method 550.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage medium storing machine-readable code, computer readable code, and/or program code, referred hereafter as code. The computer readable storage medium may be tangible, non-transitory, and/or non-transmission. The computer readable storage medium may not embody signals. In a certain embodiment, the storage devices only employ signals for accessing code.

The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

A common problem faced in the retail environment for consumer-packaged goods (CPG) is figuring out how to place items on store shelves. It is well understood that what product a customer chooses to pick from a shelf is highly correlated with both which shelf and where on the aisle that product is. Therefore, CPG companies spend a lot of effort negotiating planograms with stores to agree where their products are placed. CPG companies regularly conduct audits of stores to perform a number of functions. These functions may include, but are not limited to, planogram compliance, competitive analysis, and out of stock analysis. During these store audits auditors may use cameras on handheld devices (like cell phones) to take pictures of shelves. Computer vision software is used to both segment these images to draw bounding boxes around each product and to identify each product according to its stock keeping unit (SKU). This analysis allows the audit to take place quickly and accurately.

Training these computer vision models to understand the vast number of SKUs each CPG company manages is difficult. Traditionally these models are trained in a supervised fashion, both to draw bounding boxes around products and then label the appropriate SKU. In order to train these models, people will create labeled data, whereby they are presented with an image of a product and have to associate the correct SKU to it. Modern computer vision algorithms require at least tens of examples of a product in order to teach the algorithm what it looks like. This can be challenging, both for infrequent SKUs or for a large number of SKUs. Specifically, finding the required tens of samples of a product may become burdensome as the number of examples of unlabeled products in a given visual database grows. The embodiments solve this problem and allow a computer to more efficiently classify products.

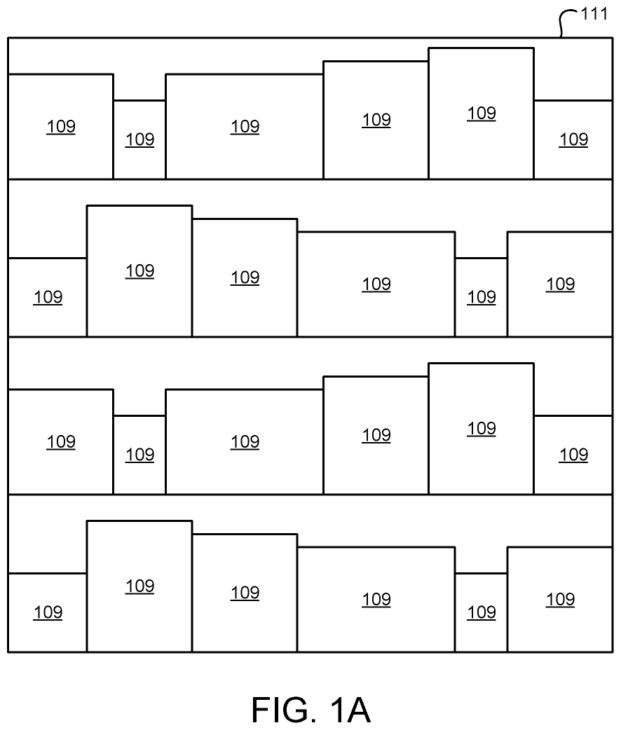

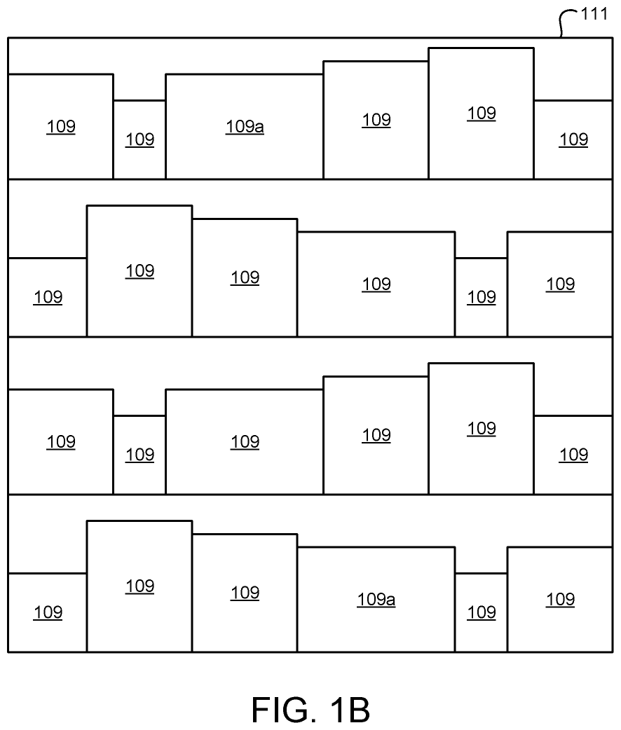

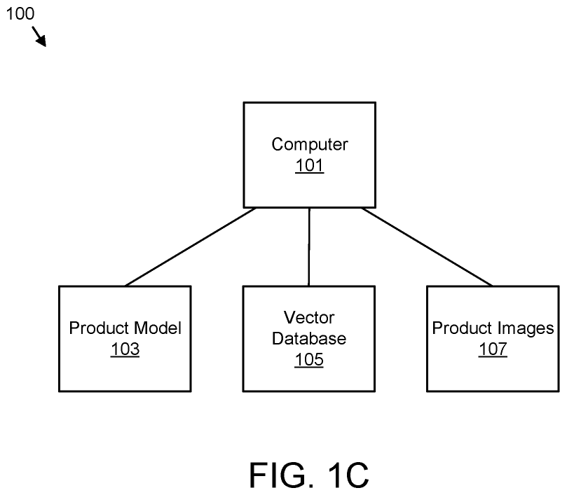

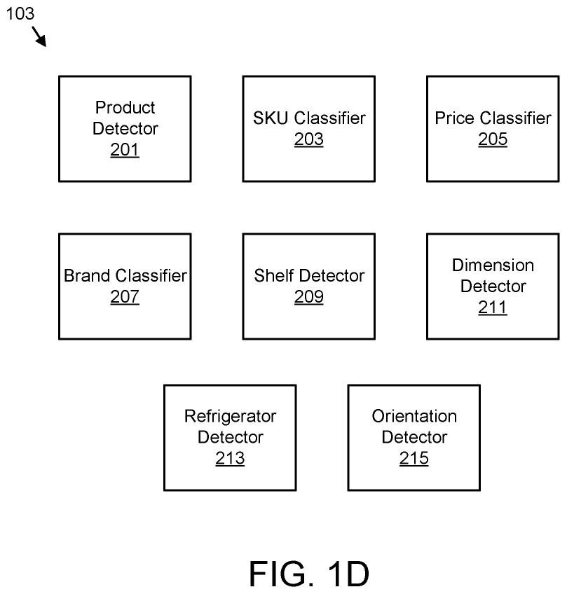

FIG. 1A is a schematic drawing illustrating one embodiment of a shelf 111. The shelf 111 may be disposed in a retail establishment. The shelf 111 may contain a plurality of products 109. The products 109 may have a variety of sizes, shapes, and appearances.

It is often desirable to determine what products 109 are on the shelf 111, where products 109 are positioned on the shelf 111, and how much of each product 109 is on the shelf 111. Such information may be used to determine the success of an advertising campaign, perform an audit, and/or determine compliance with contractual placement requirements. A product classifier may be used to identify products 109 on an image of the shelf 111. Information on the products 109 can then be calculated.

FIG. 1B is a schematic drawing illustrating one alternate embodiment of a shelf 111. Unfortunately, because products 109 are frequently introduced and/or modified, it is difficult for a product classifier to accurately determine which products 109 are in an image of the shelf 111. In the depicted embodiment, one or more new products 109a are disposed on the shelf 111. As used herein, a new product 109a may include a product 109 that is new in all aspects, an existing product 109 with a new view, an existing product 109 with new packaging, and the like. The new products 109a may not be recognized by the product classifier. The embodiments described herein add new products 109 to a product classifier using product images extracted from a vector database as will be described hereafter.

FIG. 1C is a schematic block diagram illustrating one embodiment of a classification system 100. The classification system 100 may classify products 109 such as new products 109a so that the products 109 may be recognized by the product classifier. In the depicted embodiment, the classification system 100 includes a computer 101, a product model 103, the vector database 105, and the product images 107.

A plurality of product images 107 may be parsed from images of shelves 111. The product model 103 may be a supervised learning model. The product model 103 may characterize the plurality of product images 107 of products 109 as product embeddings in the vector database 105 along one or more embedding axes. Product embedding groups in the vector database 105 may be used to identify products 109 as will be described hereafter.

FIG. 1D is a schematic block diagram illustrating one embodiment of the product model 103. In the depicted embodiment, the product model 103 includes the product classifier 201, an SKU classifier 203, a price detector 205, a brand classifier 207, a shelf detector 209, a dimension estimator 211, a refrigerator detector 213, and an orientation estimator 215.

The product classifier 201 detects products 109, empty space, and specified products 109 in product image 107. The product classifier 201 may detect a product 109 within an image such as a product image 107 and/or a shelf image. The SKU classifier 203 classifies an SKU for a product 109. In one embodiment, the SKU classifier 203 includes but is not limited to a beer model, a wine and spirits model, and a non-alcoholic beverage model.

The price detector 205 may identify a price for a product 109. In addition, the price detector 205 may associate a price with the product 109. In one embodiment, the price detector 205 classifies price tags, price boxes with price tags, and price digits within price boxes. The brand classifier 207 may identify and/or classify a brand for a product 109. The shelf detector 209 may identify elements of a shelf 111. In one embodiment, the shelf detector 209 detects shelves 111 and placement 269 within shelves 111.

The dimension estimator 211 may identify dimensions in an image. The dimensions may include shelf dimensions and/or product dimensions. In one embodiment, the dimension estimator 211 maps pixel dimensions of a product image 107 to physical dimensions.

The refrigerator detector 213 detects a refrigerator door on a shelf 111. The refrigerator detector 213 may identify that a shelf 111 is within a refrigerator. The orientation estimator 215 determines a side that a product 109 is facing. The orientation estimator 215 may determine the orientation of a shelf 111 and/or a product 109.

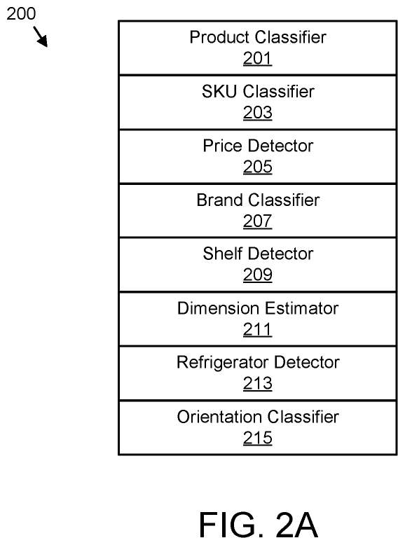

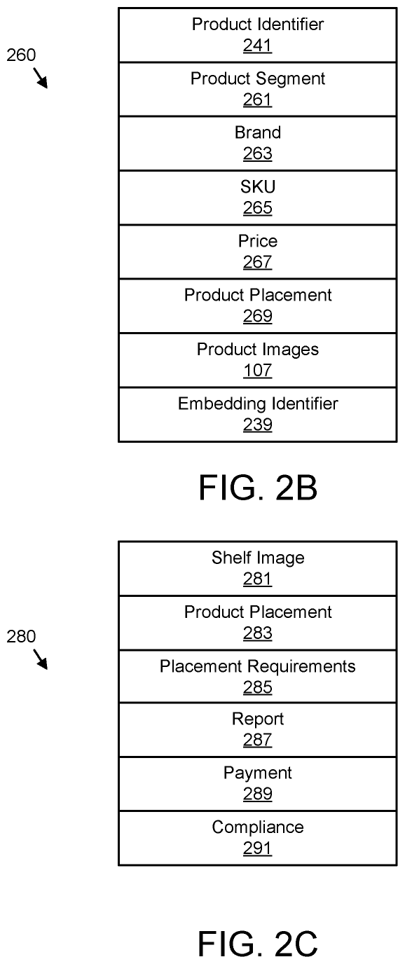

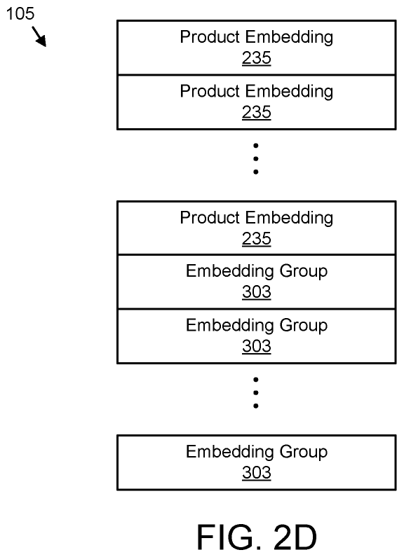

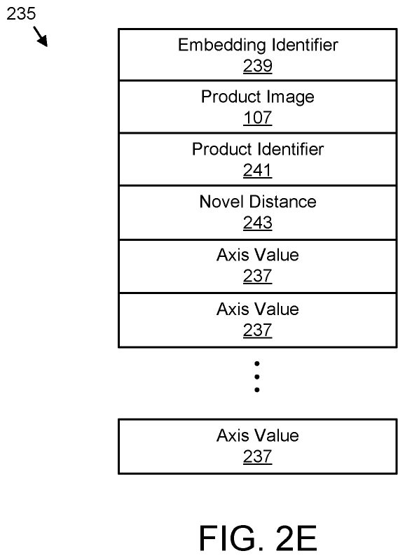

FIG. 2A is a schematic block diagram illustrating one embodiment of classification data 200. The classification data 200 is used to classify a product 109 from an image. The classification data 200 may be organized as a data structure in a memory. In the depicted embodiment, the classification data 200 includes the product classifier 201, the SKU classifier 203, the price detector 205, the brand classifier 207, the shelf detector 209, the dimension estimator 211, the refrigerator detector 213, and the orientation estimator 215. The product classifier 201, the SKU classifier 203, the price detector 205, the brand classifier 207, the shelf detector 209, the dimension estimator 211, the refrigerator detector 213, and the orientation estimator 215 may be stored as algorithms and/or data for an algorithm.

FIG. 2B is a schematic block diagram illustrating one embodiment of product data 260. The product data 260 may describe a product 109. The product 109 may be linked to a product vector 235 in the vector database 105. The product data 260 may be organized as a data structure in a memory. In the depicted embodiment, the product data 260 includes a product identifier 241, a product segment 261, a brand 263, an SKU 265, a price 267, a product placement 269, product images 107, and an embedding identifier 239.

The product identifier 241 may identify the product 109 to the vector database 105. The product segment 261 may specify a segment such as spirits comprising the product 109. The brand 263 specifies the brand, distributor, and/or manufacturer of the product 109. The SKU 265 identifies the SKU for the product 109. The price 267 specifies the product price. The product placement 269 identifies a placement of the product 109 on a shelf 111. The product images 107 include at least one image of the product 109. The embedding identifier 239 may link to a product embedding when the product embedding is identified as the product 109.

FIG. 2C is a schematic block diagram illustrating one embodiment of shelf data 280. The shelf data 280 may be generated for a specific shelf 111 and/or group of shelves 111 such as a spirit's aisle. In one embodiment, the shelf data 280 is generated from a shelf image 281. The shelf data 280 may be organized as a data structure in a memory. In the depicted embodiment, the shelf data 280 includes the shelf image 281, a product placement 283, placement requirements 285, a report 287, a payment 289, and a compliance 291.

The shelf image 281 may comprise at least one image of a specific shelf 111 and/or group of shelves 111. In a certain embodiment, the shelf image 281 comprises a time series of images of the shelf 111 and/or group of shelves 111.

The placement requirements 285 may specify planogram compliance, competitive analysis criteria, and/or out of stock analysis criteria. The compliance 291 may be the percentage that the product placement 283 matches placement requirements 285. The report 287 may detail compliance of product placements 269 to the placement requirements 285. The payment 289 may be made based on compliance 291 of product placements 269 to the placement requirements 285.

FIG. 2D is a schematic block diagram illustrating one embodiment of the vector database 105. The vector database 105 stores a plurality of product embeddings 235 for a plurality of products 109 and a plurality of embedding groups 303 for the product embeddings 235. The vector database 105 stores and defines a plurality of product embeddings 235 in a virtual latent space. A plurality of product embeddings 235 may be organized in an embedding group 303 within the virtual latent space. The vector database 105 comprises product embeddings 235 of known products 109 and unknown products 109. The vector database 105 may be organized as a data structure in a memory.

FIG. 2E is a schematic block diagram illustrating one embodiment of the product embedding 235. The product embedding 235 may include an embedding identifier 239, the product image 107 from which the product embedding 235 is created, a corresponding product identifier 241, a novel distance 243, and one or more axis values 237.

The product identifier 241 may link the product embedding 235 to a product 109 and/or product data 260. If the product 109 is unknown for the product embedding 235, the product identifier 241 may be undefined. If the product 109 is known, the product identifier 241 links to the product 109 and product data 260.

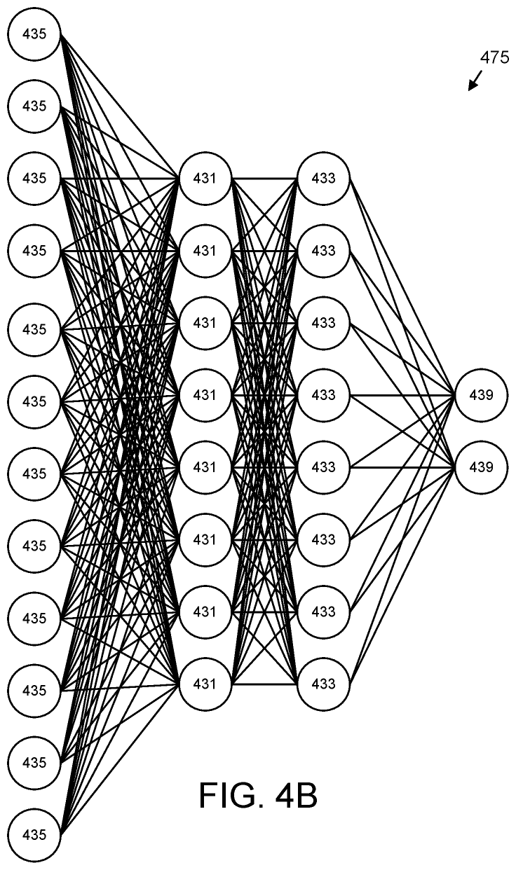

The novel distance 243 may specify a virtual distance within the vector database 105 from an embedded product 235 to another embedded product 235 and/or embedding group 303. The axis values 237 may position the product embedding 235 and/or product 109 within the virtual latent space of the vector database 105 as will be shown hereafter. The generation of the axis values 237 is described in more detail in FIG. 4B.

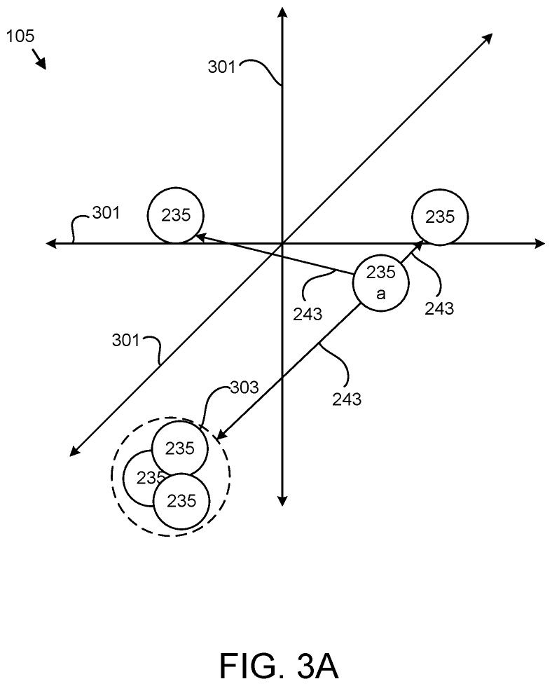

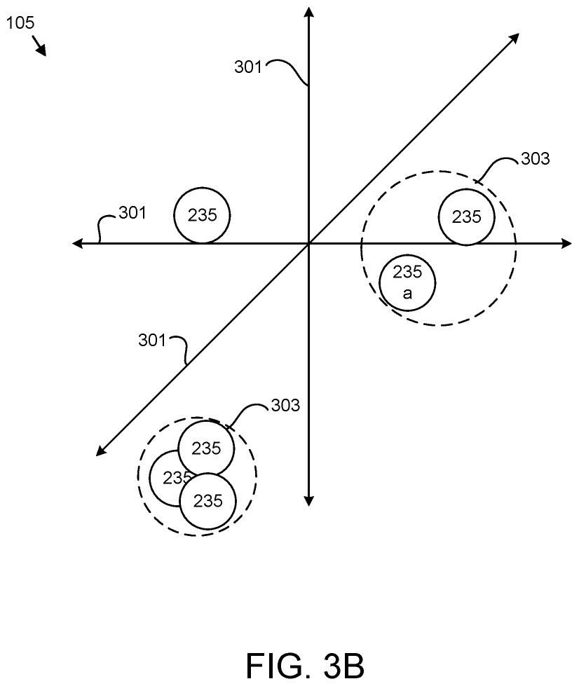

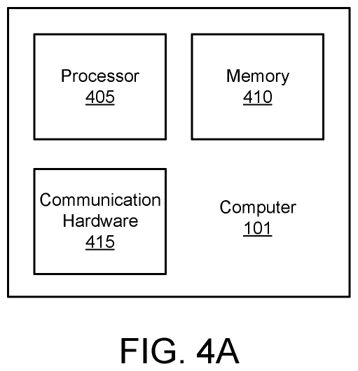

FIG. 3A is a diagram illustrating one embodiment of a vector database 105. The virtual latent space of the vector database 105 is shown. The virtual latent space of the vector database 105 is defined by a plurality of embedding axes 301. In the depicted embodiment, three embedding axes 301 are shown. However, any number of embedding axes 301 may be employed. The axis values 237 of each product embedding 235 position the product embedding 235 within the virtual latent space of the vector database 105.

The embodiments train the product model 103 to embed product images 107 as product embeddings 235. Product embedding 235 may be generated in a number of ways, including training the product classifier 201 as a neural network and then removing the last layer(s) of the neural network. In addition, product embeddings 235 may be generated from a metric learning product classifier 201 by feeding the product classifier 201 pairs or triplets of product images 107 and then encouraging the product classifier 201 to push product embeddings 235 of the same product 109 close to each other in the virtual latent space. As a result, product embeddings 235 of the same product 109 are positioned close to one another in the latent space of the vector database 105.

After the product classifier 201 is trained, product images 107 of products 109 are passed through the product classifier 201 and a product embedding 235 is generated for each product image 107. The product images 107 of segmented products 109 with a same or similar product segment 261 may be passed through the product classifier 201. These product embeddings 235 are then all fed into the vector database 105, resulting in the depicted virtual latent space. When a new product 109a appears in a product image 107 and/or shelf image 281, the new product 109a is embedded as a new product embedding 235a in the vector database 105. This new product embedding 235a is then used as the centroid for a nearest neighbor query in the vector database. The nearest neighbor query may identify the novel distance 243 between the new product embedding 235a and other product embeddings 235 and/or product embedding groups 303.

The nearest neighbor query will return all the product embeddings 235 of product images 107 which are “close.” As used herein, a close product embedding 235 and/or product embedding group 303 is either, less than a novel distance threshold to a target product embedding or within the top K results 235 such as a new product embedding 235a. The product images 107 with product embeddings 235 which are close overwhelmingly are of the same product 109 as used to generate the vector database 105. The new product embedding 235a, and other embedding which are close, may be quickly labeled with the appropriate SKU 265 and/or product identifier 241. In addition, the product model 103 may be retrained with the new product identifier 235a. This process greatly reduces the amount of both time and effort necessary to teach the product model 103 about new SKUs 265 and/or products 109. This improves efficiency of the classification system 100 as the system 100 can keep up with the rapid change in inventories and stay current with new products 109 appearing on the shelves 111 of stores.

FIG. 3B is a diagram illustrating one embodiment of the vector database 105 of FIG. 3A. In the depicted embodiment, the new product embedding 235a is clustered with the product embedding with either the closest novel distance 243 less than the novel distance threshold to form a new product embedding group 303 or is within the top K items.

FIG. 4A is a schematic block diagram illustrating one embodiment of the computer 101. In the depicted embodiment, the computer 101 includes at least one processor 405, at least one memory 410, and communication hardware 415. The at least one memory 410 may store code and data. The at least one processor 405 may execute the code and process the data. The at least one processor 405 and the least one memory 410 may include a neural network as will be described hereafter. The communication hardware 415 may communicate with other devices.

FIG. 4B is a schematic diagram illustrating one embodiment of a neural network 475. The neural network 475 may be embodied in one or more computers 101. The product model 103 may comprise the neural network 475. The neural network 475 includes a plurality of input neurons 435, a plurality of embedding dimension neurons 431, a plurality of hidden neurons 433, and a plurality of axis value neurons 439. The input neurons 200 encode characteristics of a product image 107. The embedding dimension neurons 231 correlate the characteristics of the input neurons 435 to embedding dimensions.

For simplicity, a single layer of hidden neurons 433 is shown. However, any number of hidden neurons 433 may be organized in any number of layers. The hidden neurons 433 generate inputs to the axis value neurons 439 from the hidden neurons 433. The axis value neurons 439 generate the axis values 437 for the product image 107. Although for simplicity only two axis value neurons 439 are shown, any number of axis value neurons 439 may be employed.

The neural network 475 may be trained to classify images using supervised or unsupervised learning. The weights of the embedding dimension neurons 431 and the hidden neurons 433 may be adjusted using a training algorithm such as backpropagation until the axis value neurons 439 express the known axis values 237. This process is repeated for a plurality of product images 107.

The product model 103 may generate a product embedding 235 for a product image 107 by applying input values for the product image 107 to the input neurons 435. The product classifier 201, the SKU classifier 203, the price detector 205, the brand classifier 207, the shelf detector 209, the dimension estimator 211, the refrigerator detector 213, and/or the orientation estimator 215 may provide the input values. The embedding dimensions neurons 431, hidden neurons 433, and axis value neurons 439 may then generate the axis values 237 for the product image 107.

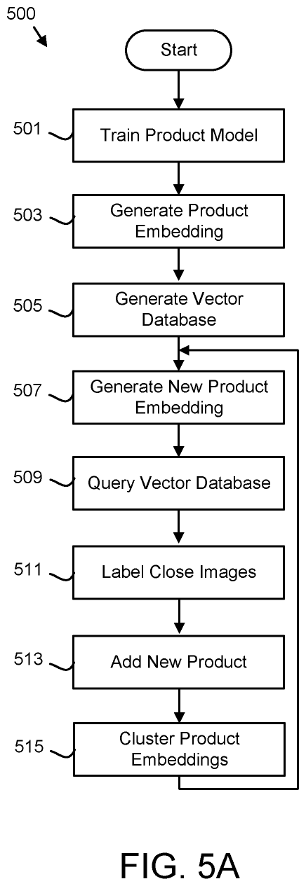

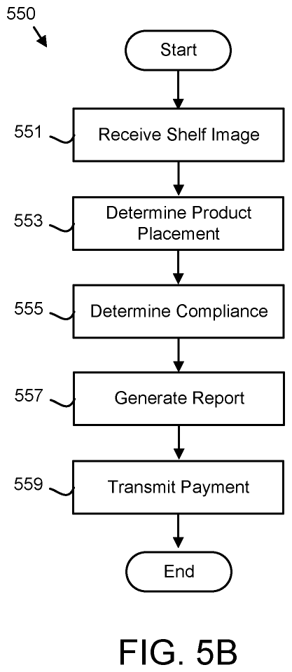

FIG. 5A is a schematic flow chart diagram illustrating one embodiment of a product classification method 500. The method 500 may automatically classify products 109. The method 500 may be performed by the classification system 100 and/or computer 101. In addition, the method 500 may be performed by a processor 405.

The method 500 starts, and in one embodiment, the method 500 trains 501 the product model 103. In one embodiment, the product model 103 is trained 501 as a supervised model. Alternatively, the product model may be trained 501 as an unsupervised model. The product model 103 embeds product embeddings 235 of a same product 109 close to another product 109 in a latent space of a vector database 105.

The method 500 may generate 503 a product embedding 235 for a plurality of product images 107 of products 109 using the product model 103. The products 109 may be segmented products 109.

The method 500 may generate 505 the vector database 105 of the product embeddings 235 for the plurality of the product images 107. The vector database 105 may be generated 505 by positioning product embedding 235 within the latent space. The vector database 105 comprises product embeddings 235 of known products 109 and/or unknown products 109.

The method 500 generates 507 a new product embedding 235a for a new product 109a. The new product embedding 235 may be generated 507 by a neural network 475 as described in FIG. 4B.

The method 500 queries 509 the vector database 105 with the new product embedding 235 as a centroid for a proximity query. The proximity query may calculate the novel distance 243 to a plurality of product embeddings 235 and/or product embedding groups 303. The new product embedding 235 is a novel distance 243 from other product embeddings 235 in the vector database 105.

The method 500 labels 511 close product embeddings 235 and/or close product embedding group 303 from the vector database 105 as the products 109 and/or new product 109a. A close product embedding 235 and/or product embedding group 303 may have a novel distance 243 that is less than a novel distance threshold to the new product embedding 235 or be within the top K embeddings by distance. In one embodiment, the embodiment identifier 239 and product identifier 241 link the product embedding 235 and product data 260 to label 511 the new product 109a as the close product embeddings 235 and/or close product embedding group 303.

The method 500 adds the new product 109a to the product classifier 201 using product images 107 extracted from within a product embedding group 303 of the vector database 105. At least two product embeddings 235 may comprises a product embedding group 303.

The method 500 may cluster 515 product embeddings 235 as product embedding group 303. In one embodiment, each product embedding 235 with a novel distance 243 to a centroid of a potential product embedding group 303 that is less than a group distance threshold is clustered in the potential product embedding group 303.

By generating the new product embedding 235a and labeling/associating the new product embedding with close product embedding 235, the method 500 allows the computer 101 to quickly and efficiently include new products 109a in the vector database 105.

FIG. 5B is a schematic flow chart diagram illustrating one embodiment of a compliance determination method 550. The method 550 may determine if placement requirements 285 are satisfied. The method 550 may be performed by the compliance system 100 and/or computer 101. In addition, the method 550 may be performed by a processor 405.

The method 550 starts, and in one embodiment, the method 550 receives 551 a shelf image 281. The method 550 further determines 553 the product placement 269 for each product 109 identified by the product classifier 201 in the shelf image 281. The method 550 determines 555 compliance 291 of the product placement 269 to the placement requirements 285 by comparing the product placement 269 to the placement requirements 285. In one embodiment, the product placement 283 is compared to the placement requirements 285 for target products 109 to calculate the compliance 291.

The method 550 may generate 557 a report 287 based on the compliance 291. The report 287 may state a percentage compliance 291 with the placement requirements 285 for one or more products 109. The report 287 may further state a percentage compliance 291 for a group of products 109.

In one embodiment, the method 550 transmits 559 a payment 289 in response to the compliance 291 exceeding a compliance threshold and the method ends. The compliance threshold may be in the range of 90-100 percent.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
training, by use of a processor, a product model comprising a product detector, a Stock Keeping Unit (SKU) classifier, a price detector, a brand classifier, a shelf detector, a dimension estimator, a refrigerator detector, and an orientation classifier, wherein the product model embeds product embeddings of a same product close to another product in a latent space of a vector database;
generating a product embedding for a plurality of product images of segmented products using the product model;
generating the vector database of the product embeddings for the plurality of the product images, wherein the vector database comprises product embeddings of known products and unknown products;
generating a new product embedding for a new product or different views or packaging of already known products;
querying the vector database with the new product embedding as a centroid for a proximity query, wherein the new product embedding is a novel distance from other product embeddings in the vector database;
labeling close product embeddings from the vector database as the new product; and
adding the new product to the product detector using product images extracted from within a product embedding group of the vector database.

2. The method of claim 1, the method further comprising:
receiving a shelf image;
determining a product placement; and
determining compliance with placement requirements.

3. The method of claim 1, wherein the product detector detects products, empty space, and specified products in product image.

4. The method of claim 1, wherein the SKU classifier classifies a SKU of a product.

5. The method of claim 4, wherein the SKU classifier comprises a beer model, a wine and spirits model, and a non-alcoholic beverage model.

6. The method of claim 1, wherein the price detector classifies price tags, price boxes with price tags, and price digits within price boxes.

7. The method of claim 1, wherein the brand family classifier classifies a brand of a product.

8. The method of claim 1, wherein the shelf detector detects shelves and product placement within shelves.

9. The method of claim 1, wherein the dimension estimator maps pixel dimensions of a product image to physical dimensions.

10. The method of claim 1, wherein the refrigerator detector detects a refrigerator door on a shelf.

11. The method of claim 1, wherein the orientation classifier determines a side a product is facing.

12. An apparatus comprising:
a processor executing code stored in a memory to perform:
training a supervised learning product model comprising a product detector, a Stock Keeping Unit (SKU) classifier, a price detector, a brand classifier, a shelf detector, a dimension estimator, a refrigerator detector, and an orientation classifier, wherein the product model embeds product embeddings of a same product close to another product in a latent space of a vector database;
generating a product embedding for a plurality of product images of segmented products using the product model;
generating the vector database of the product embeddings for the plurality of the product images, wherein the vector database comprises product embeddings of known products and unknown products;
generating a new product embedding for a new product;
querying the vector database with the new product embedding as a centroid for a proximity query, wherein the new product embedding is a novel distance from other product embeddings in the vector database;
labeling close product embeddings from the vector database as the new product; and
adding the new product to the product detector using product images extracted from within a product embedding group of the vector database.

13. The apparatus of claim 12, the processor further:
receiving a shelf image;
determining a product placement; and
determining compliance with placement requirements.

14. The apparatus of claim 12, wherein the product detector detects products, empty space, and specified products in product image.

15. The apparatus of claim 12, wherein the SKU classifier classifies a SKU of a product.

16. The apparatus of claim 15, wherein the SKU classifier comprises a beer model, a wine and spirits model, and a non-alcoholic beverage model.

17. A computer program product comprising a non-transitory storage medium storing code executable by a processor to perform:
training a product model comprising a product detector, a Stock Keeping Unit (SKU) classifier, a price detector, a brand classifier, a shelf detector, a dimension estimator, a refrigerator detector, and an orientation classifier, wherein the product model embeds product embeddings of a same product close to another product in a latent space of a vector database;
generating a product embedding for a plurality of product images of segmented products using the product model;
generating the vector database of the product embeddings for the plurality of the product images, wherein the vector database comprises product embeddings of known products and unknown products;
generating a new product embedding for a new product;
querying the vector database with the new product embedding as a centroid for a proximity query, wherein the new product embedding is a novel distance from other product embeddings in the vector database;
labeling close product embeddings from the vector database as the new product; and
adding the new product to the product detector using product images extracted from within a product embedding group of the vector database.

18. The computer program product of claim 17, the processor further:
receiving a shelf image;
determining a product placement; and
determining compliance with placement requirements.

19. The computer program product of claim 17, wherein the product detector detects products, empty space, and specified products in product image.

20. The computer program product of claim 17, wherein the SKU classifier classifies a SKU of a product.
